(19) United States
(12) Patent Application Publication
(10) Pub. No.: US 2024/0219212 A1
(43) Pub. Date: Jul. 4, 2024

(54) FLOW METER

(71) Applicant: Franklin Electric Co., Inc., Fort Wayne, IN (US)

(72) Inventor: Russell Bookout, Fort Wayne, IN (US)

(21) Appl. No.: 18/432,443

(22) Filed: Feb. 5, 2024

Related U.S. Application Data
(63) Continuation of application No. 18/510,103, filed on Nov. 15, 2023.
(60) Provisional application No. 63/383,893, filed on Nov. 15, 2022.

(51) Int. Cl. G01F 1/115

(52) U.S. Cl. CPC G01F 1/115

(57) ABSTRACT

A flow meter may be used, e.g., in a residential water system to provide accurate metering across a wide range of flow rates. The flow meter uses bearing surfaces and structures which combine low friction with high load capacity, allowing for aggressive turbine blade design. Additionally, the flow meter provides enhanced design for manufacturability for low cost without performance penalties, as well as features which facilitate in situ cleaning and maintenance over the service life of the flow meter.

### CROSS-REFERENCE TO RELATED APPLICATIONS

This application claims the benefit of U.S. patent application Ser. No. 18/510,103, filed Nov. 15, 2023, which claims the benefit of U.S. Provisional Application No. 63/383,893, filed Nov. 15, 2022, the entire disclosures of which being expressly incorporated by reference herein.

### TECHNICAL FIELD

The present disclosure relates to flow measurement and, in particular, to devices for measuring flow in a residential water system.

### BACKGROUND

Flow meters are used to determine the rate and/or volume of flow through a conduit. In the context of residential water systems, flow meters may be used to measure flow rates and accumulated flow at and through various parts of the system.

### SUMMARY

The present disclosure provides a flow meter which may be used, e.g., in a residential water system to provide accurate metering across a wide range of flow rates. The flow meter uses bearing surfaces and structures which combine low friction with high load capacity, allowing for aggressive turbine blade design. Additionally, the flow meter provides enhanced design for manufacturability for low cost without performance penalties, as well as features which facilitate in situ cleaning and maintenance over the service life of the flow meter.

In one form thereof, the present disclosure provides a flow meter including a turbine having a hub and a plurality of blades extending radially outward from the hub, the turbine having a central bore formed therein, a turbine core receivable within the central bore of the turbine, the turbine core including a plurality of radial bearing surfaces therewithin, and a ball bearing disposed between the turbine and the turbine core.

In another form thereof, the present disclosure provides a flow meter including a turbine having a hub and a plurality of blades extending radially outward from the hub, the turbine having a central bore formed therein, and a turbine core receivable within the central bore of the turbine and being formed from a monolithic single piece of material, the turbine core including a plurality of radial bearing surfaces therewithin, the plurality of radial bearing surfaces integrally formed as a portion of the monolithic single piece of material of the turbine core.

According to one embodiment of the disclosure, a flow meter is provided, comprising: a turbine having a hub and a plurality of blades extending radially outward from the hub, the turbine having a central bore formed therein: a turbine core receivable within the central bore of the turbine, the turbine core including a plurality of radial bearing surfaces therewithin: and a ball bearing disposed between the turbine and the turbine core. In one aspect of this embodiment, the turbine core includes at least one magnet positioned to periodically align with a magnetic sensor as the turbine and the turbine core rotate in response to a flow of fluid. In a variant of this aspect, the at least one magnet is received within at least one recess formed in an outer surface of a flange of the turbine core. In another aspect, the turbine core includes a shaft having a longitudinally extending bore sized to receive an axle on which the turbine and the turbine core rotate in response to a flow of fluid. In a variant of this aspect, the ball bearing is at least partially disposed within the longitudinally extending bore of the turbine core and captured between a bearing seat formed within the central bore of the turbine and a set of bearing pads formed within the longitudinally extending bore. In another variant, the ball bearing engages a substantially flat thrust bearing surface formed on an end of the axle. Yet another variant further comprises a plurality of axially spaced sets of bearing pads formed on an inner surface of the longitudinally extending bore of the shaft of the turbine core to provide a low-friction interface between the turbine core and the axle as the turbine and the turbine core rotate in response to a flow of fluid. In a further variant, the plurality of axially spaced sets of bearing pads includes three sets of bearing pads spaced evenly about a circumference of the longitudinally extending bore, each set of bearing pads including a first bearing pad disposed adjacent a first end of the longitudinally extending bore and a second bearing pad disposed adjacent a second end of the longitudinally extending bore, the second end being opposite the first end. In another aspect of this embodiment, the turbine core includes a plurality of retainer clips which are received by a corresponding plurality of retainer receivers formed in the turbine when the turbine core is received within the central bore of the turbine. In a variant of this aspect, the retainer receivers are openings that extend between an inner surface of the central bore of the turbine and an outer surface of the hub. In another variant, the central bore of the turbine includes a key and the turbine core includes a keyway configured to receive the key to provide alignment of the plurality of retainer clips with the plurality of retainer receivers. In still another variant, the central bore of the turbine includes a plurality of notches positioned to receive the plurality of retainer clips. In another aspect, the turbine core includes a keyway that aligns with a key formed in the central bore of the turbine to prevent relative rotation of the turbine and the turbine core. In yet another aspect, the flow meter further comprises a plurality of bearings disposed within the turbine core, the plurality of bearings including a first bearing disposed adjacent a first end of a longitudinally extending bore of the turbine core and a second bearing disposed adjacent a second end of the longitudinally extending bore. In another aspect, the turbine core includes a first cylindrical bearing surface adjacent a first end of the turbine core and a second cylindrical bearing surface adjacent a second end of the turbine core. In still another aspect, the turbine core includes a pair of keyways extending from an outer surface of the turbine core and the central bore of the turbine includes a plurality of arms that define a pair of keys for receiving the pair of keyways.

In another embodiment, the present disclosure provides a flow meter, comprising: a turbine having a hub and a plurality of blades extending radially outward from the hub, the turbine having a central bore formed therein, the central bore including a plurality of retainer receivers: and a turbine core receivable within the central bore of the turbine and including a plurality of retainer clips configured to be received by the plurality of retainer receivers, a first cylindrical bearing surface positioned adjacent a first end of the turbine core and a second cylindrical bearing surface positioned adjacent a second end of the turbine core that is opposite the first end. In one aspect of this embodiment, the turbine core includes an end cap having an inner surface that engages a substantially flat thrust bearing surface formed on an end of an axle on which the turbine and the turbine core rotate in response to a flow of fluid. In another aspect, the turbine core also includes a pair of keyways that engage a corresponding pair of keys defined by inwardly directed arms formed in the central bore of the turbine.

In yet another embodiment, the present disclosure provides a flow meter assembly, comprising: a housing having an opening: an axle having a first end connected to the housing inside the opening: a sensor positioned in the housing adjacent the opening, the sensor being electrically coupled to a controller: a turbine having a hub and a plurality of blades extending radially outward from the hub, the turbine having a central bore formed therein; and a turbine core receivable within the central bore of the turbine and within the opening of the housing, the turbine core including an end cap having an inner surface that engages a bearing surface formed on a second end of the axle: wherein the sensor sense rotation of the turbine and the turbine core about the axle and provides a signal to the controller. In one aspect of this embodiment, the turbine core includes a flange at a first end of the turbine core, and at least one magnet mounted to the flange such that rotation of the turbine core one the axle is sensed by the sensor as a change in magnetic field caused by the proximity of the at least one magnet to the sensor. In another aspect, the turbine core includes a first cylindrical bearing surface positioned adjacent the first end of the turbine core and a second cylindrical bearing surface positioned adjacent a second end of the turbine core that is opposite the first end.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a perspective view of a flow meter made in accordance with the present disclosure:

FIG. 2 is an exploded, perspective view of a turbine assembly used in the flow meter of FIG. 1:

FIG. 3 is another exploded view of the turbine assembly of FIG. 2:

FIG. 4 is an elevation, section view of the flow meter of FIG. 1, taken along the line 4-4:

FIG. 5 is an elevation, section view of the flow meter of FIG. 1, taken along the line 5-5:

FIG. 6 is an exploded, partial section view of components of the turbine assembly of FIG. 2:

FIG. 7(a) is a perspective, exploded view of another exemplary turbine assembly made in accordance with the present disclosure:

FIG. 7(b) is a perspective view of a portion of a turbine of the assembly of FIG. 7(a):

FIG. 7(c) is a perspective view of a turbine core of the assembly of FIG. 7(a):

FIG. 8(a) is a perspective view of a pair of mold cores uses to produce a turbine core made in accordance with the present disclosure, shown in a disassembled configuration:

FIG. 8(b) is another perspective view of the mold cores of FIG. 8(a), shown partially assembled:

FIG. 8(c) is another perspective view of the mold cores of FIG. 8(a), shown fully assembled:

FIG. 9 is a perspective, exploded view of an alternative flow meter made in accordance with the present disclosure;

FIG. 10 is a perspective, section view of a turbine assembly of the flow meter of FIG. 9:

FIG. 11 is another perspective, section view of a turbine assembly of the flow meter of FIG. 9:

FIGS. 12-15 are various views of components of a turbine assembly according to another embodiment of the present disclosure:

FIG. 16 includes various views of the turbine assembly of FIGS. 12-15 installed in a housing:

FIG. 17 is an enlarged, perspective view of the turbine core depicted in FIG. 12:

FIG. 18 is an enlarged, cross-sectional view of the turbine core of FIG. 17 installed in the turbine depicted in FIG. 12; and

FIG. 19 includes enlarged views of the turbine core depicted in FIG. 15.

Corresponding reference characters indicate corresponding parts throughout the several views. Unless stated otherwise the drawings are proportional and drawn to scale.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings.

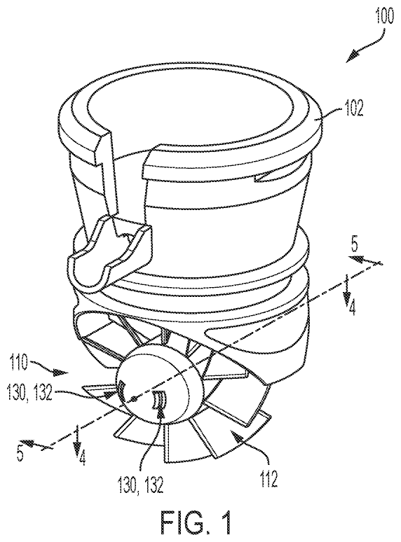

The present disclosure provides a flow meter 100, shown in FIG. 1, including a turbine assembly 110 with low-friction components allowing turbine 112 to spin even when flows of fluid past turbine 112 are very low. Additionally, the components of turbine 112 are designed for efficient and precise manufacture, as detailed further below.

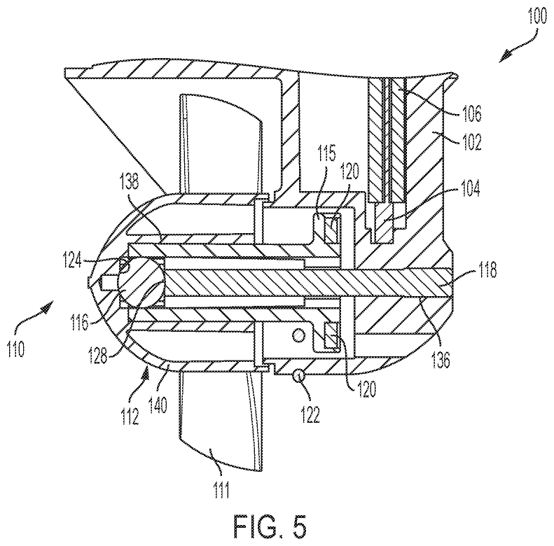

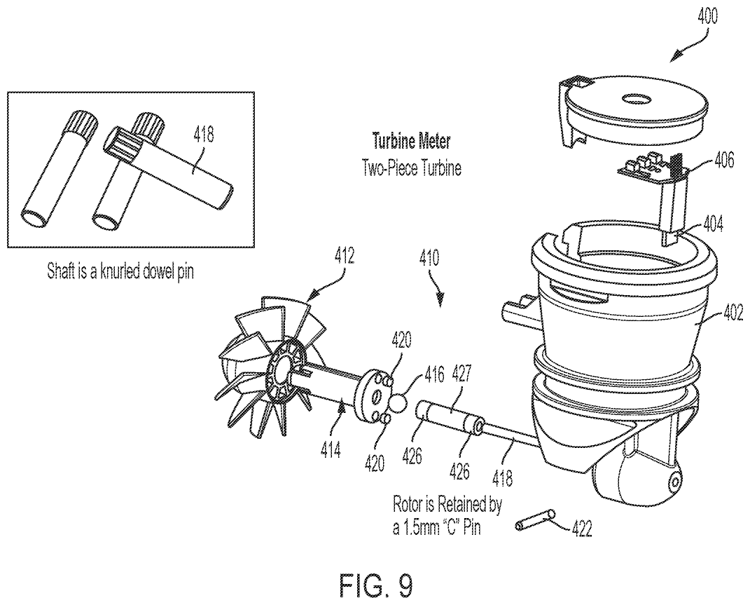

Flow meter assembly 100 includes housing 102 which is configured for installation on a conduit carrying flows of fluid. For example, housing 102 may be configured for incorporation into a residential water system, such that flow meter 100 measures flows of water through the system. As shown in FIG. 5, housing contains a magnetic sensor 104 which is coupled to spacer 106 and electrically incorporated into a controller (not shown, but similar or identical to controller 406 shown in FIG. 9), which may be a printed circuit board, for example. It should be understood that other types of sensors (i.e., not magnetic) such as electrical sensors, optical sensors, mechanical sensors, etc. may be used in alternative embodiments. Turbine 112 is rotatably coupled to housing 102, as further described below, such that a pair of magnets 120 aligned with opposite polarity pass by sensor 104 as the turbine 112 rotates. This causes a change in magnetic field that the sensor 104 senses. Each such pass creates a pulse registered by the controller, which is programmed to calculate an amount of fluid flow corresponding to each pulse. As pulses accumulate, the controller is programmed to record and tabulate an amount of accumulated flow, thereby creating a metered flow amount.

In one exemplary embodiment, the controller may be programmed with a threshold flow amount, such as an amount corresponding to a desired amount of cumulative flow for a particular use. When the metered flow amount registered by the controller reaches the threshold flow amount, the controller may initiate an action, e.g., turning off a pump or actuating a valve or other system component. In another embodiment, the controller may be programmed to initiate an action when flow corresponding to a system leak is detected.

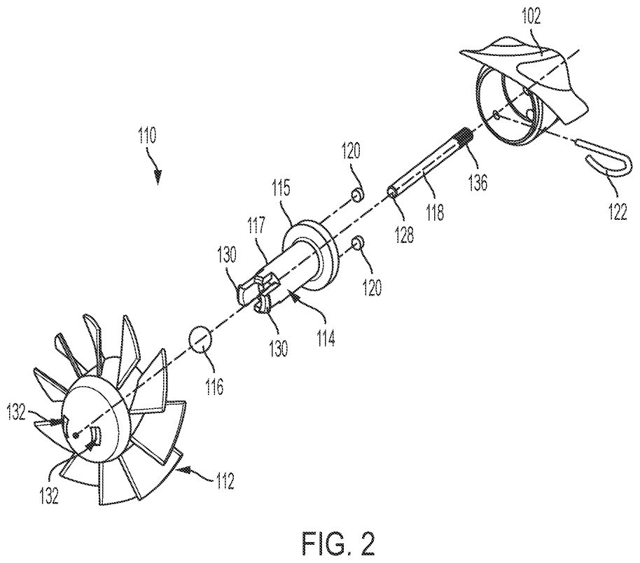

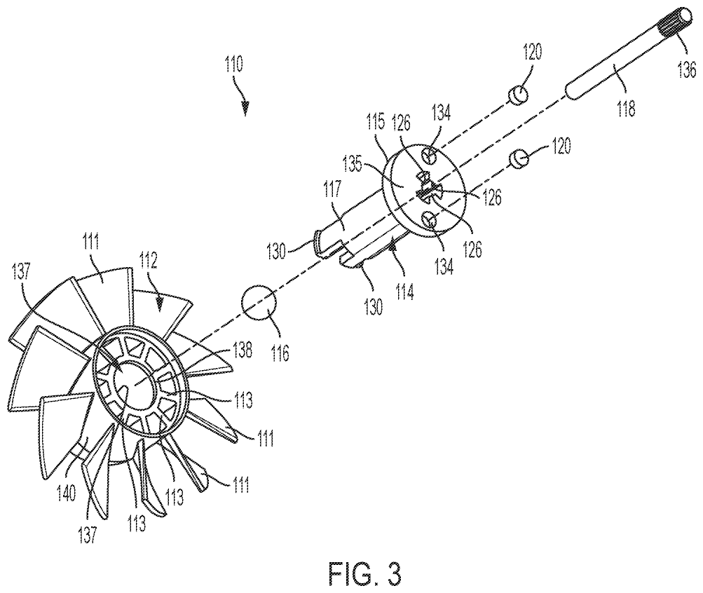

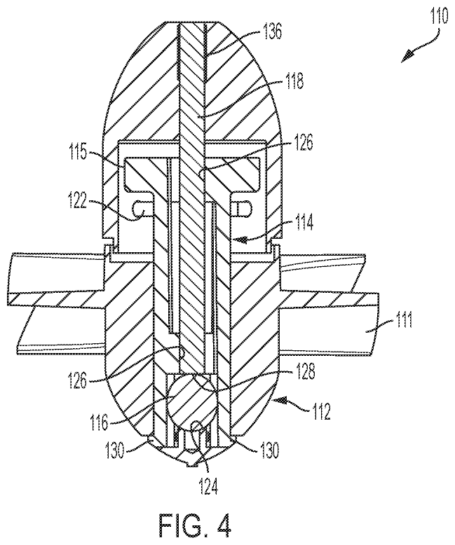

As best seen in FIGS. 2-5, turbine assembly 110 includes turbine 112 having a central bore 137 having an inner surface 139 defined inside of an inner wall 138 thereof (FIG. 3). Turbine core 114 is receivable within the central bore 137, with ball bearing 116 disposed between turbine 112 and turbine core 114 as best seen in FIGS. 4 and 5. Magnets 120 are received in correspondingly sized recesses 134 formed in an outer surface 135 of a flange 115 of the core 114 (FIG. 3). Turbine assembly 110 is rotatably received upon axle 118, as further described below: Axle 118 may be fixed to housing 102 by a knurled end portion 136.

Turbine assembly 110 is generally axially urged to remain on axle 118 by the flow passing over the outer wall 140 of turbine 112 (FIG. 3) during operation. However, a turbine retainer clip 122 is also provided, as shown in FIGS. 2 and 5, to axially retain turbine assembly 110 upon axle 118 in the event of fluid backflow. Retainer clip 122 has a straight portion which passes through a pair of apertures in housing 102 and a “D” shaped portion which resiliently deforms during installation and snaps into registration with the outer surface of housing 102 when fully seated. The straight portion of the retainer clip 122 provides a physical barrier to the flange 115 of turbine core 114, preventing removal of turbine assembly 110 when clip 122 is in place. However, as shown in FIG. 5, clip 122 is axially spaced from turbine core 114 during normal operation (i.e., when turbine assembly 110 is fully seated on axle 118), such that clip 122 does not frictionally interact with turbine assembly 110 except during backflow situations.

Turbine 112 and turbine core 114 are each monolithically formed components made from a single piece of material. For example, turbine core 114 may be made of a plastic or metal material with suitable bearing qualities which may be molded or cast. Turbine 112 may be made of a molded plastic material with suitable bearing qualities. Ball bearing 116 may be a sphere made of a hard and lubricious material such as ceramic, particularly silicon nitride or silicon carbide. Magnets 120 may be any magnetic or magnetizable material, such as rare earth magnets.

Turbine core 114 has a generally cylindrical shaft 117 with a larger-diameter cylindrical flange 115 formed at its base. The axial end of the shaft 117, opposite the flange 115, has an opening sized to receive and radially capture ball bearing 116, as shown in FIGS. 4 and 5. A longitudinally extending bore 119 extends through the shaft 117 and receives the axle 118. When core 114 is assembled to turbine 112, ball bearing 116 is captured between a bearing seat 124 formed within the bore of turbine 112 and a set of bearing pads 126 of core 114 (further described below). This allows the ball bearing 116 to be easily pre-assembled as a part of turbine assembly 110, including during installation or field servicing.

When turbine assembly 110 is assembled to housing 102, ball bearing 116 comes into contact with a substantially flat thrust bearing surface 128 formed at the axial end of axle 118, as shown in FIGS. 4 and 5. Ball bearing 116 and bearing surface 128 cooperate to provide a small-area, but high-capacity, thrust bearing which minimizes friction in both low-flow and high-flow situations as fluid passes over turbine 112 during operation of flow meter assembly 100.

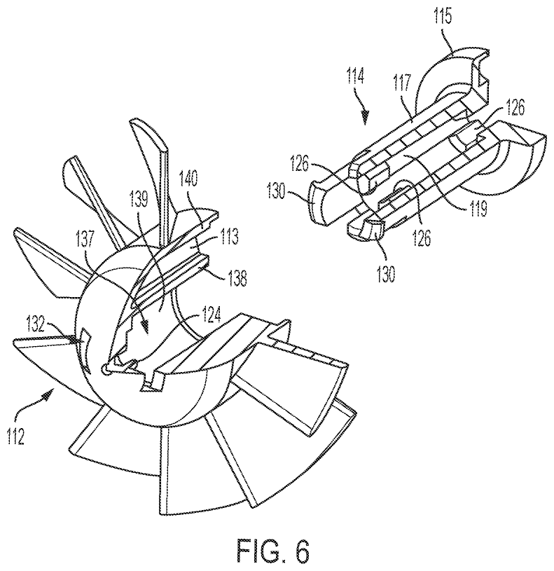

Radial bearing support for turbine assembly 110 is provided by at least two axially-spaced sets of bearing pads 126 which are integrally formed as a part of the monolithic single component of turbine core 114 on an inner surface 127 of the longitudinally extending bore 119, as best seen in FIG. 6. As illustrated, each set of bearing pads 126 may be a set of three pads 126 spaced evenly (i.e., spaced about 120 degrees apart) about the circumference of the bore formed through turbine core 114. The respective sets of pads 126 are positioned at opposing axial ends of the bore. The sets of pads may be rotated with respect to one another (e.g., by about 60 degrees) to maximize radial support by providing support on opposing sides of the axle 118, as best seen in FIG. 4. The illustrated arrangement provides a low-friction interface between axle 118 and turbine assembly 110, minimizing starting torque in low-flow situations while retaining a high-performance radial bearing. However, the number and arrangement of bearing pads 126 in each set, and the number of sets of bearing surfaces, may be modified as required or desired for a particular application.

As shown in, e.g., FIG. 2, axle 118 has a substantially consistent diameter across its entire axial extent. This reduces cost as compared to custom-fabricated axles which may have steps and other variable-diameter features incorporated therein. Moreover, axle 118 can be readily manufactured from a simple piece of rod stock in a single step, namely, knurling an end portion of the rod to create end portion 136.

FIGS. 3 and 5 illustrate that the design of turbine 112 allows for a low variation in material thickness throughout the volume of turbine 112. For example, a hub portion of the turbine 112 includes a plurality of webs 113, inner wall 138, and outer wall 140. The webs 113 are used to bridge the gap between the inner and outer walls 138, 140 of turbine 112, such that the inner wall 138, webs 113, and outer wall 140 all have a substantially equal thickness, such as within 5% of one another. Additionally, these thicknesses may also be substantially equal to the thicknesses of the blades 111 of the turbine, such as within 15% of one another. This consistency among thicknesses facilitates manufacture of turbine 112 by promoting consistent cooling and/or shrinkage after a molding process, for example.

Referring now to FIG. 2, turbine core 114 may include retainer clips 130 at its axial end which are designed to interface with retainer receivers 132 formed in turbine 112. During assembly of turbine assembly 110, turbine core 114 is advanced into the central bore 137 of turbine 112 as shown in FIGS. 4 and 5. As the turbine core 114 approaches its final seated position within the bore, clips 130 resiliently deform radially inwardly until they reach registration with receivers 132. At this point, as shown in FIG. 4, the clips 130 spring back to their original position, axially fixing turbine core 114 relative to turbine 112. If it is later desired to disassemble turbine assembly 110, retainer clips 130 can be compressed inwardly (such as by pliers or a similar tool) and turbine core 114 can be withdrawn.

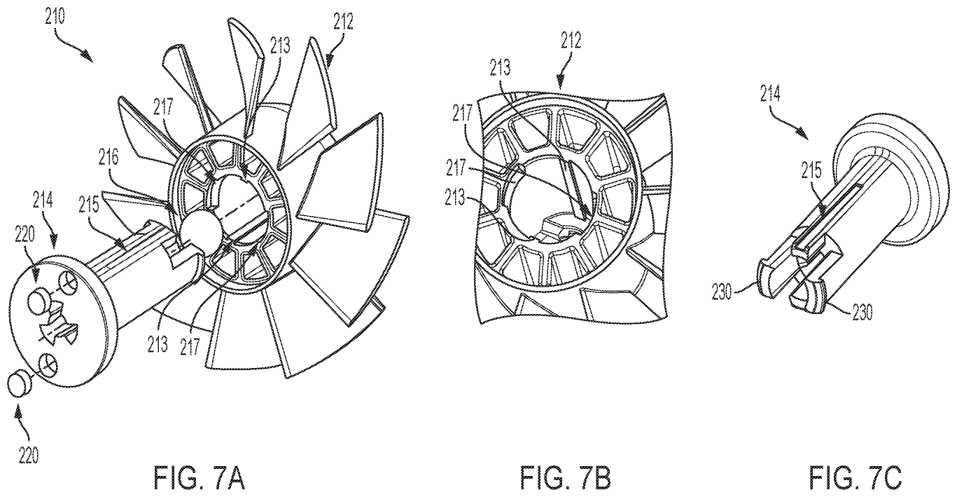

Turning now to FIGS. 7(a)-7(c), an alternative arrangement of turbine assembly 110 is shown as turbine assembly 210. Reference numbers of turbine assembly 210 correspond to the same structures as reference numbers of turbine assembly 110, except with 100 added thereto. However, core 214 includes a keyway 215 which aligns with key 213 formed in the bore of turbine 212 to prevent relative rotation therebetween and ensure proper alignment between retainer clips 230 and retainer receivers 232 upon assembly. Initial orientation of core 214 relative to turbine 212 may be further facilitated with the provision of notches 217, which are positioned and configured to receive clips 230 upon initial engagement between core 214 and turbine 212. Notches 217 may also include gradually ramped surfaces which help to urge clips 230 into their resiliently deformed position as core 214 is pushed into the bore of turbine 212.

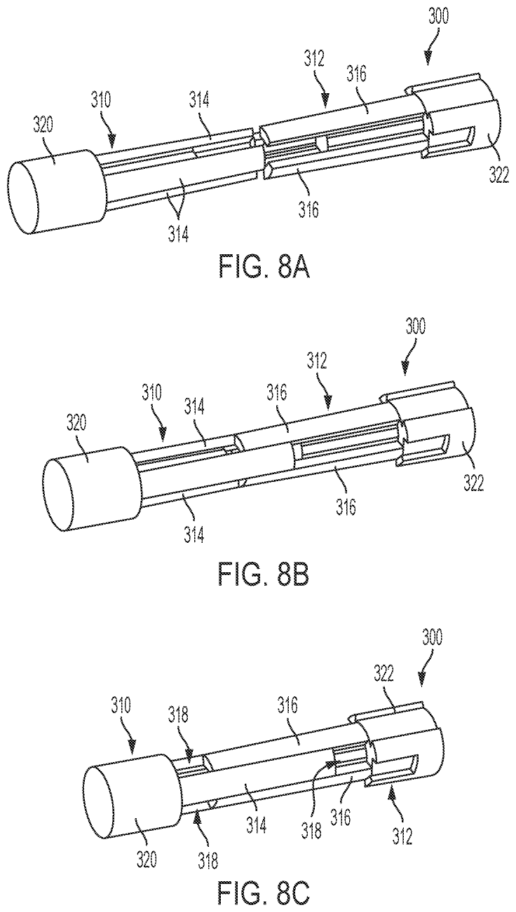

Turning now to FIGS. 8(a)-8(c), a mold core assembly 300 is shown which facilitates production of turbine core 114 or 214. Mold core assembly includes a first mold core 310 and a second mold core 312 which are configured to interfit. In particular, mold core 310 includes three arms 314 which are sized and positioned to fit between corresponding spaces between three similar arms 316 of mold core 312, as shown in FIG. 8(a). Arms 314, 316 are passed along one another's length, as shown in FIG. 8(b), until fully seated as shown in FIG. 8(c). When fully seated, voids 318 are formed in the remaining spaces between the ends of arms 314, 316 and the respective hubs 320, 322 of mold cores 310, 312. The mold core assembly 300 is then used to create a casting or mold in which bearing pads 126 (FIG. 6) are formed by material flow into voids 318.

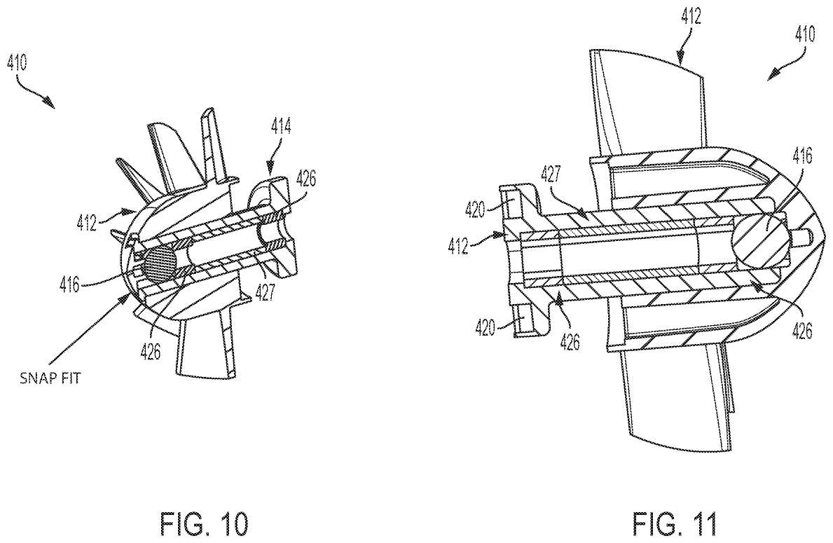

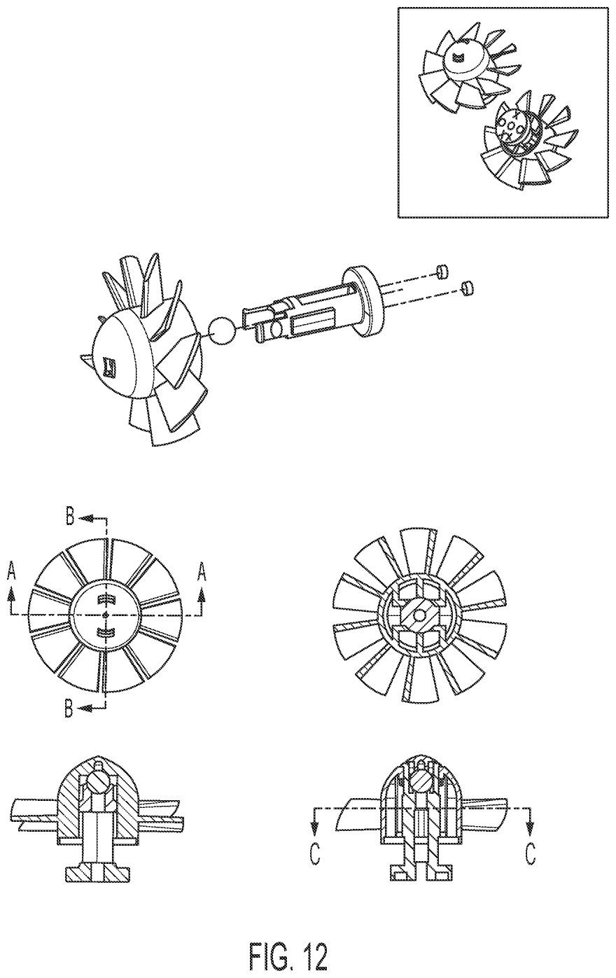

FIGS. 9-11 shown another alternative turbine assembly 410. Reference numbers of turbine assembly 410 correspond to the same structures as reference numbers of turbine assembly 110, except with 300 added thereto. However, turbine assembly 410 includes separate bearings 426 instead of bearing pads 126. Bearings 426 may be formed of a lubricious material, such as PEEK, and separately assembled within a bore of turbine core 414 as shown in FIGS. 10 and 11. If multiple bearing sleeves are used, a spacer 427 may be disposed axially between the bearings 426, thereby ensuring that each bearing 426 is retained in their desired locations at opposite axial ends of the bore in core 414.

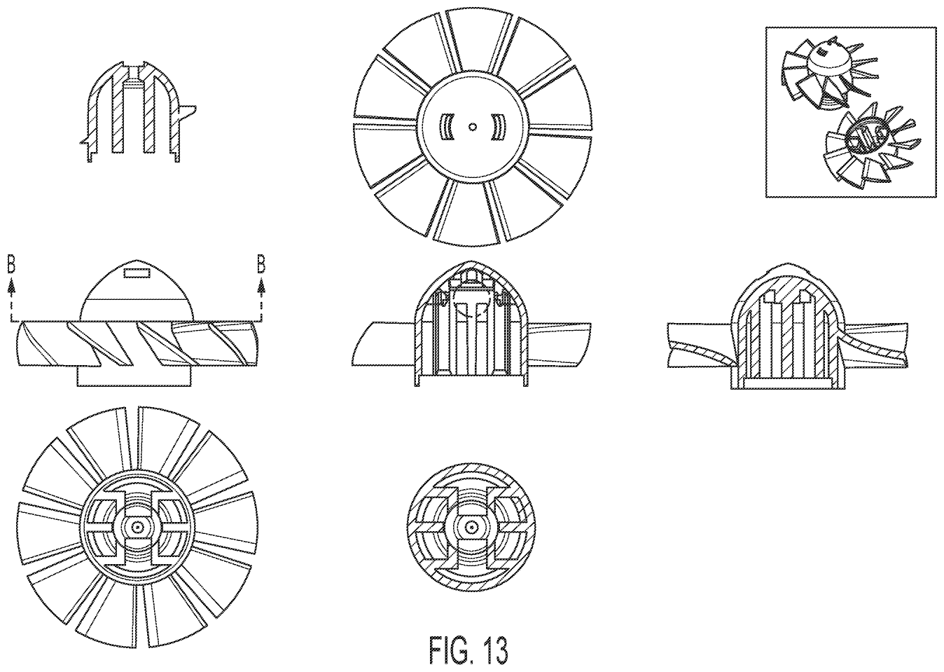

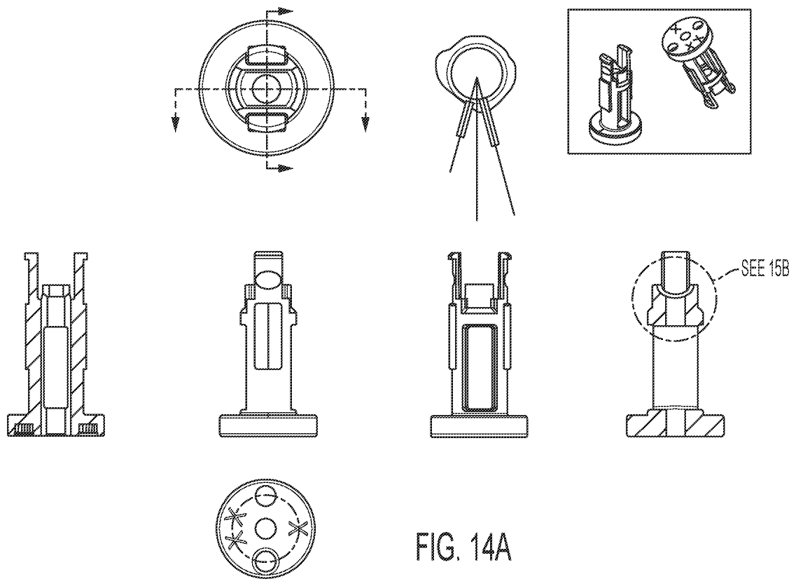

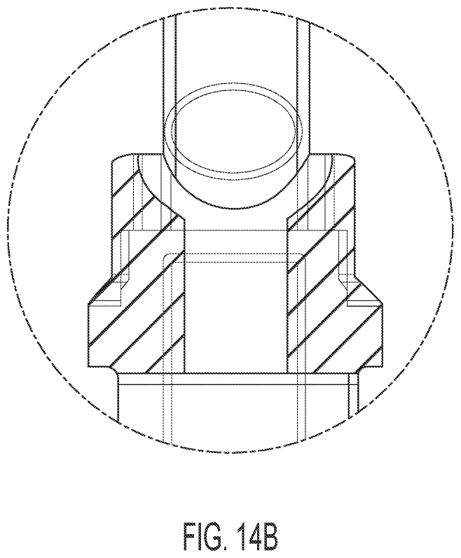

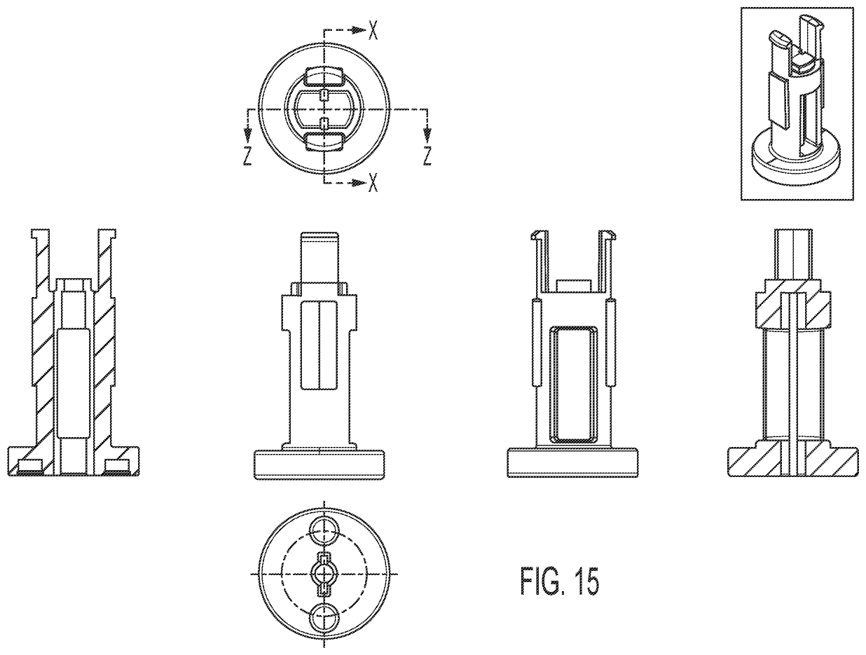

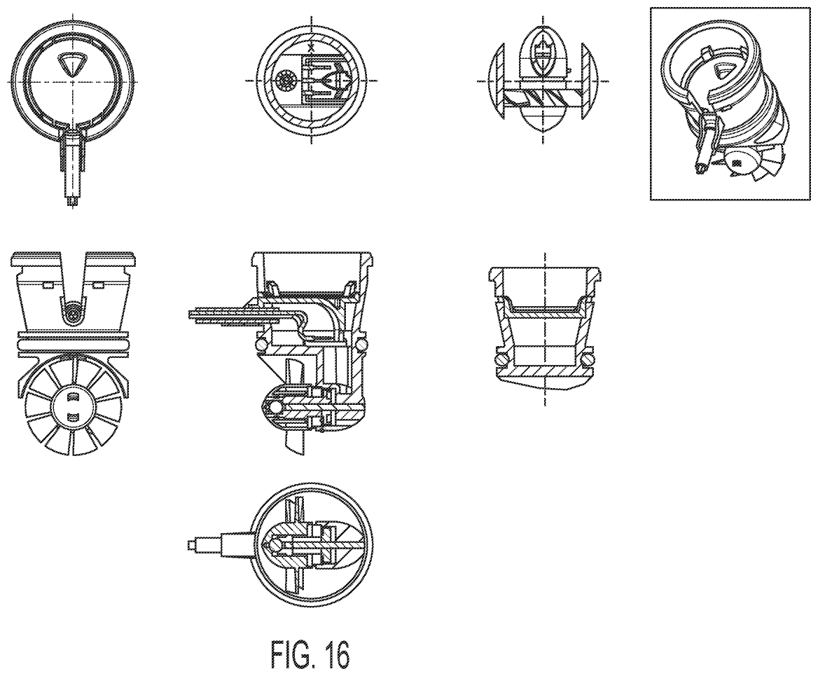

FIGS. 12 and 14 depicts an alternative embodiment of a turbine core according to the present disclosure. FIG. 13 depicts an alternative embodiment of a turbine according to the present disclosure. FIG. 15 depicts an alternative embodiment of a turbine core according to the present disclosure. FIG. 16 depicts an alternative embodiment of a flow meter assembly similar to that depicted in FIG. 1.

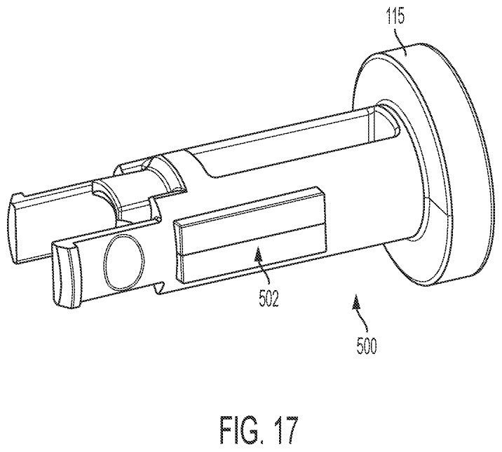

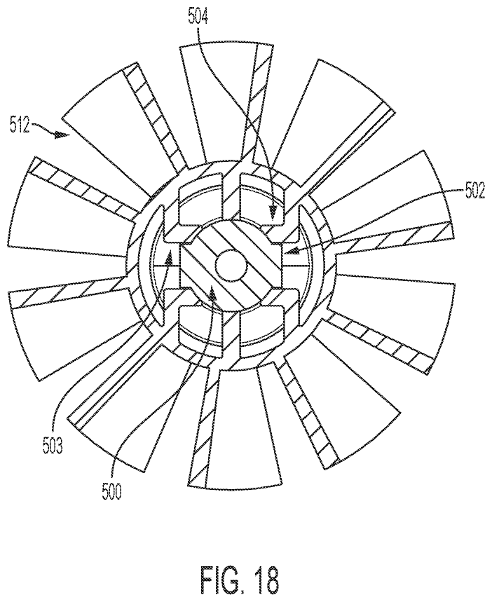

Referring now to FIG. 17, an enlarged view of the turbine core of FIG. 12 is provided. The turbine core 500 is substantially similar to the turbine core 114 depicted in FIG. 2. The turbine core 500, however, includes a pair of keyways 502 extending from the outer surface of the turbine core 500. As shown in FIG. 18, the keyways 502 of the turbine core 500 fit between arms 504 (which together define a pair of keys 503) formed inside the central bore 137 of the turbine 512 depicted in FIG. 12. In this manner, the alignment of the keyways 502 and the arms 504 ensure the proper orientation and lack of relative rotation between the turbine core 500 and the turbine 512.

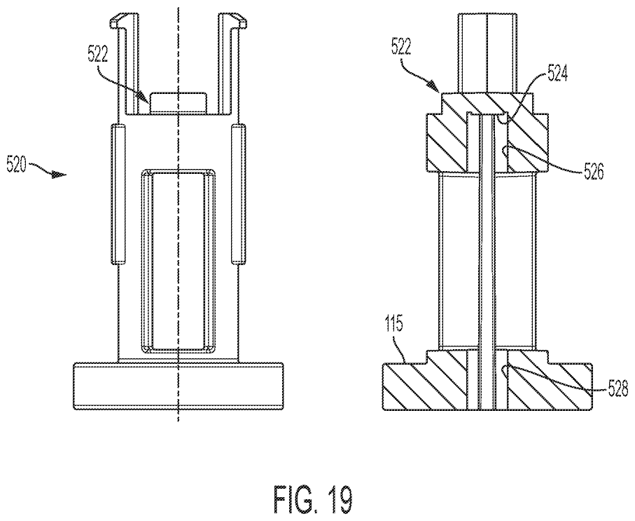

Referring now to FIG. 19, an enlarged view of the turbine core 520 depicted in FIG. 15 is provided. In this alternative embodiment, the turbine core 520 includes an end cap 522 at the end of the turbine core 520. The end cap 522 includes an inner surface 524 which is convex inwardly as shown. When the turbine core 520 is installed onto the axle (e.g., axle 118 of FIG. 4), the inner surface 524 of the end cap 522 comes into contact with a thrust bearing surface 128 formed at the axial end of axle 118, as shown in FIGS. 4 and 5, instead of using a ball bearing 116. The inner surface 524 and the bearing surface 128 cooperate to provide a small-area, but high-capacity, thrust bearing which minimizes friction in both low-flow and high-flow situations as fluid passes over the turbine 112 during operation of flow meter assembly 100. FIG. 19 also depicts a cylindrical bearing surface 526 disposed within the turbine core 520 adjacent the first end of the turbine core 520 (i.e., adjacent the end cap 522) and a cylindrical bearing surface 528 disposed within the turbine core 520 adjacent the second end of the turbine core 520 (i.e., adjacent the flange 115).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A flow meter, comprising:
a turbine having a hub and a plurality of blades extending radially outward from the hub, the turbine having a central bore formed therein;
a turbine core receivable within the central bore of the turbine, the turbine core including a plurality of radial bearing surfaces therewithin; and
a ball bearing disposed between the turbine and the turbine core.

2. The flow meter of claim 1, wherein the turbine core includes at least one magnet positioned to periodically align with a magnetic sensor as the turbine and the turbine core rotate in response to a flow of fluid.

3. The flow meter of claim 2, wherein the at least one magnet is received within at least one recess formed in an outer surface of a flange of the turbine core.

4. The flow meter of claim 1, wherein the turbine core includes a shaft having a longitudinally extending bore sized to receive an axle on which the turbine and the turbine core rotate in response to a flow of fluid.

5. The flow meter of claim 4, wherein the ball bearing is at least partially disposed within the longitudinally extending bore of the turbine core and captured between a bearing seat formed within the central bore of the turbine and a set of bearing pads formed within the longitudinally extending bore.

6. The flow meter of claim 4, wherein the ball bearing engages a substantially flat thrust bearing surface formed on an end of the axle.

7. The flow meter of claim 4, further comprising a plurality of axially spaced sets of bearing pads formed on an inner surface of the longitudinally extending bore of the shaft of the turbine core to provide a low-friction interface between the turbine core and the axle as the turbine and the turbine core rotate in response to a flow of fluid.

8. The flow meter of claim 7, wherein the plurality of axially spaced sets of bearing pads includes three sets of bearing pads spaced evenly about a circumference of the longitudinally extending bore, each set of bearing pads including a first bearing pad disposed adjacent a first end of the longitudinally extending bore and a second bearing pad disposed adjacent a second end of the longitudinally extending bore, the second end being opposite the first end.

9. The flow meter of claim 1, wherein the turbine core includes a plurality of retainer clips which are received by a corresponding plurality of retainer receivers formed in the turbine when the turbine core is received within the central bore of the turbine.

10. The flow meter of claim 9, wherein the retainer receivers are openings that extend between an inner surface of the central bore of the turbine and an outer surface of the hub.

11. The flow meter of claim 9, wherein the central bore of the turbine includes a key and the turbine core includes a keyway configured to receive the key to provide alignment of the plurality of retainer clips with the plurality of retainer receivers.

12. The flow meter of claim 9, wherein the central bore of the turbine includes a plurality of notches positioned to receive the plurality of retainer clips.

13. The flow meter of claim 1, wherein the turbine core includes a keyway that aligns with a key formed in the central bore of the turbine to prevent relative rotation of the turbine and the turbine core.

14. The flow meter of claim 1, further comprising a plurality of bearings disposed within the turbine core, the plurality of bearings including a first bearing disposed adjacent a first end of a longitudinally extending bore of the turbine core and a second bearing disposed adjacent a second end of the longitudinally extending bore.

15. The flow meter of claim 1, wherein the turbine core includes a first cylindrical bearing surface adjacent a first end of the turbine core and a second cylindrical bearing surface adjacent a second end of the turbine core.

16. The flow meter of claim 1, wherein the turbine core includes a pair of keyways extending from an outer surface of the turbine core and the central bore of the turbine includes a plurality of arms that define a pair of keys for receiving the pair of keyways.

17. A flow meter, comprising:
a turbine having a hub and a plurality of blades extending radially outward from the hub, the turbine having a central bore formed therein, the central bore including a plurality of retainer receivers; and
a turbine core receivable within the central bore of the turbine and including a plurality of retainer clips configured to be received by the plurality of retainer receivers, a first cylindrical bearing surface positioned adjacent a first end of the turbine core and a second cylindrical bearing surface positioned adjacent a second end of the turbine core that is opposite the first end.

18. The flow meter of claim 17, wherein the turbine core includes an end cap having an inner surface that engages a substantially flat thrust bearing surface formed on an end of an axle on which the turbine and the turbine core rotate in response to a flow of fluid.

19. The flow meter of claim 17, wherein the turbine core also includes a pair of keyways that engage a corresponding pair of keys defined by inwardly directed arms formed in the central bore of the turbine.

20. A flow meter assembly, comprising:
a housing having an opening;
an axle having a first end connected to the housing inside the opening;
a sensor positioned in the housing adjacent the opening, the sensor being electrically coupled to a controller;
a turbine having a hub and a plurality of blades extending radially outward from the hub, the turbine having a central bore formed therein; and
a turbine core receivable within the central bore of the turbine and within the opening of the housing, the turbine core including an end cap having an inner surface that engages a bearing surface formed on a second end of the axle;
wherein the sensor sense rotation of the turbine and the turbine core about the axle and provides a signal to the controller.

21. The flow meter assembly of claim 20, wherein the turbine core includes a flange at a first end of the turbine core, and at least one magnet mounted to the flange such that rotation of the turbine core one the axle is sensed by the sensor as a change in magnetic field caused by the proximity of the at least one magnet to the sensor.

22. The flow meter of claim 20, wherein the turbine core includes a first cylindrical bearing surface positioned adjacent the first end of the turbine core and a second cylindrical bearing surface positioned adjacent a second end of the turbine core that is opposite the first end.
